(19) United States
(12) Patent Application Publication
(10) Pub. No.: US 2007/0223553 A1
(43) Pub. Date: Sep. 27, 2007

(54) Laser system with the laser oscillator and the laser amplifier pumped by a single source

(75) Inventor: Xinbing Liu, Acton, MA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/387,575

(22) Filed: Mar. 23, 2006

(51) Int. Cl. H01S 3/091; H01S 3/092; H01S 3/094

(52) U.S. Cl. 372/70; 372/75

(57) ABSTRACT

An optically-pumped, amplified laser source including a single optical pump. The laser source includes: an optical pump to generate pump light; a laser oscillator adapted to generate laser light when irradiated with the pump light; a laser amplifier coupled to the laser oscillator to receive laser light from the laser oscillator; and beam splitting optics optically coupled to the optical pump, laser oscillator, and laser amplifier. The pump light includes a pump power and a predetermined pump wavelength and the laser light has a laser wavelength. The laser amplifier is adapted to amplify light with the laser wavelength when irradiated with light having the pump wavelength. The beam splitting optics couple a first portion of the pump light having a first fraction of the pump power into the laser oscillator and a second portion of the pump light having a second fraction of the pump power into the laser amplifier.

### FIELD OF THE INVENTION

The present invention concerns amplified laser systems having a single optical pump. In particular, these amplified laser systems may use a single optical pump to pump a laser oscillator and one or more laser amplifiers.

### BACKGROUND OF THE INVENTION

Many laser systems use an oscillator-amplifier architecture. For example, a short-pulse regenerative amplifier laser has a laser oscillator that generates a short pulse train by mode-locking. The pulse train typically has a pulse frequency (repetition rate) in tens to hundreds of megahertz, and the pulse energy is typically in the picojoule to nanojoule range. For many applications it is desirable to increase the pulse energy to microjoule to millijoule levels. The regenerative amplifier selects one pulse from the pulse train and injects the selected pulse into another laser cavity that traps the pulse for amplification. When the pulse energy of the pulse reaches a desired level, or saturation, the pulse is dumped out of the regenerative amplifier. This process is repeated at a lower frequency, typically on the order of one kilohertz to tens of kilohertz. The result is a laser output with much higher pulse energy at lower pulse frequency than the output signal of the oscillator.

Presently, many laser oscillator-amplifier systems are pumped by laser diodes. Furthermore, many systems use fiber-coupled laser diodes as optical pumps. Lasers pumped by fiber-coupled laser diodes may offer many advantages over those pumped by direct laser diodes, such as circular pump beams for better mode matching and ease of optical pump replacement.

The laser oscillator-amplifier systems that are pumped by fiber-coupled laser diodes use separate laser diodes to pump the laser oscillator and the laser amplifier. This is done because the desired pump power and pump beam profile in the gain material are typically different for the laser oscillator and the laser amplifier. For example, a laser oscillator may require 1 W of pump power and a beam size of 200 microns in the laser gain medium, while a laser amplifier used in conjunction with this laser oscillator may require 10 W of pump power and a beam size of 800 microns in the gain medium. To achieve these power levels and beam sizes, two fiber-coupled laser diodes are used: one low-power laser diode with a fiber core diameter of 100 microns delivering 1 W of power; and another high-power laser diode with fiber core diameter of 400 microns delivering 10 W of power.

FIG. 1 illustrates such a laser system that uses two fiber-coupled laser diodes 104 and 120, with two sets of laser diode power supplies 100 and 114 and two temperature controllers 102 and 116 coupled to two thermoelectric coolers (TEC's) 106 and 118. Laser diode 104 is coupled to laser oscillator 110 through optical fiber 108 and laser diode 120 is coupled to laser amplifier 124 through optical fiber 122. Laser light from laser oscillator 110 is coupled into laser amplifier 124 along beam path 112. The laser light may be directed along beam path 112 using free space optics or fiber optics.

### SUMMARY OF THE INVENTION

An exemplary embodiment of the present invention is an optically-pumped, amplified laser source including a single optical pump. The laser source includes: an optical pump to generate pump light; a laser oscillator adapted to generate laser light when irradiated with light having the pump wavelength; a laser oscillator adapted to generate laser light when irradiated with light having the pump wavelength; a laser amplifier optically coupled to the laser oscillator to receive the laser light generated by the laser oscillator; and beam splitting optics optically coupled to the optical pump, the laser oscillator, and the laser amplifier. The pump light generated by the optical pump includes a pump power level and a predetermined pump wavelength and the laser light generated by the laser oscillator has a laser wavelength. The laser amplifier is adapted to amplify light that has the laser wavelength when irradiated with light having the pump wavelength. The beam splitting optics couple a first portion of the pump light having a first fraction of the pump power level into the laser oscillator and a second portion of the pump light having a second fraction of the pump power level into the laser amplifier.

Another exemplary embodiment of the present invention is a method of optically-pumping an amplified laser source using a single optical pump. Pump light having a pump power level is generated using the single optical pump. The pump light is split into a first portion having a first fraction of the pump power level and a second portion having a second fraction of the pump power level. The first portion of the pump light is coupled into a laser oscillator to generate laser light. The second portion of the pump light and the laser light are coupled into a laser amplifier to amplify the laser light. The amplified laser light is emitted from the laser amplifier.

A further exemplary embodiment of the present invention is an optically-pumped, amplified laser source including a single optical pump. The laser source includes: an optical pump to generate pump light; a laser oscillator adapted to generate laser light when irradiated with light having the pump wavelength; a laser oscillator adapted to generate laser light when irradiated with light having the pump wavelength; a laser amplifier optically coupled to the laser oscillator to receive the laser light generated by the laser oscillator; and fiber optics optically coupled to the optical pump, the laser oscillator, and the laser amplifier. The pump light generated by the optical pump includes a pump power level and a predetermined pump wavelength and the laser light generated by the laser oscillator has a laser wavelength. The laser amplifier is adapted to amplify light that has the laser wavelength when irradiated with light having the pump wavelength. The fiber optics include: an input fiber section optically coupled to the optical pump; a first output fiber section optically coupled to the laser oscillator; a second output fiber section optically coupled to the laser amplifier; and a fiber splitter. The fiber splitter couples a first portion of the pump light having a first fraction of the pump power level from the input fiber section into the first output fiber section, and a second portion of the pump light having a second fraction of the pump power level from the input fiber section into the second output fiber section.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a top plan drawing illustrating a prior art amplified laser system.

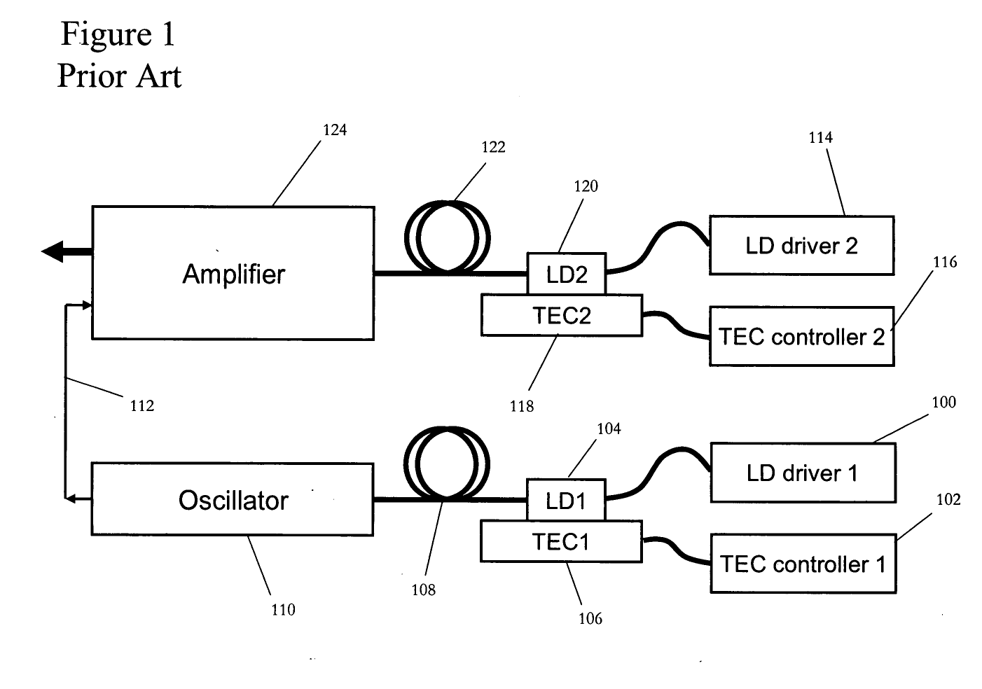

FIG. 2 is a top plan drawing illustrating an exemplary amplified laser system that has a laser oscillator, a laser amplifier, and a single optical pump optically coupled using fiber optics according to the present invention.

FIG. 3 is a top plan drawing illustrating an exemplary amplified laser system that has a laser oscillator, two laser amplifiers, and a single optical pump optically coupled using planar waveguide optics according to the present invention.

FIG. 4 is a flowchart illustrating an exemplary method of pumping an amplified laser system using a single optical pump according to the present invention.

### DETAILED DESCRIPTION OF THE INVENTION

The present invention involves a laser oscillator-amplifier system pumped by a single optical pump, such as a single fiber-coupled high-power laser diode. Compared to conventional laser systems that use separate laser diodes for oscillator and amplifier, the present invention reduces the cost and complexity of the laser system and simplifies its operation significantly.

Exemplary embodiments of the present invention involve exemplary laser oscillator-amplifier systems pumped by single optical pumps. In one exemplary embodiment this may be realized by the use of a fiber splitter with the desired power ratio and fiber core sizes to couple the optical pump into the laser oscillator and the laser amplifier. In other exemplary embodiments, planar waveguide and free space optics may be used to split the pump light power and shape the pump beams coupled into the laser oscillator and the laser amplifier.

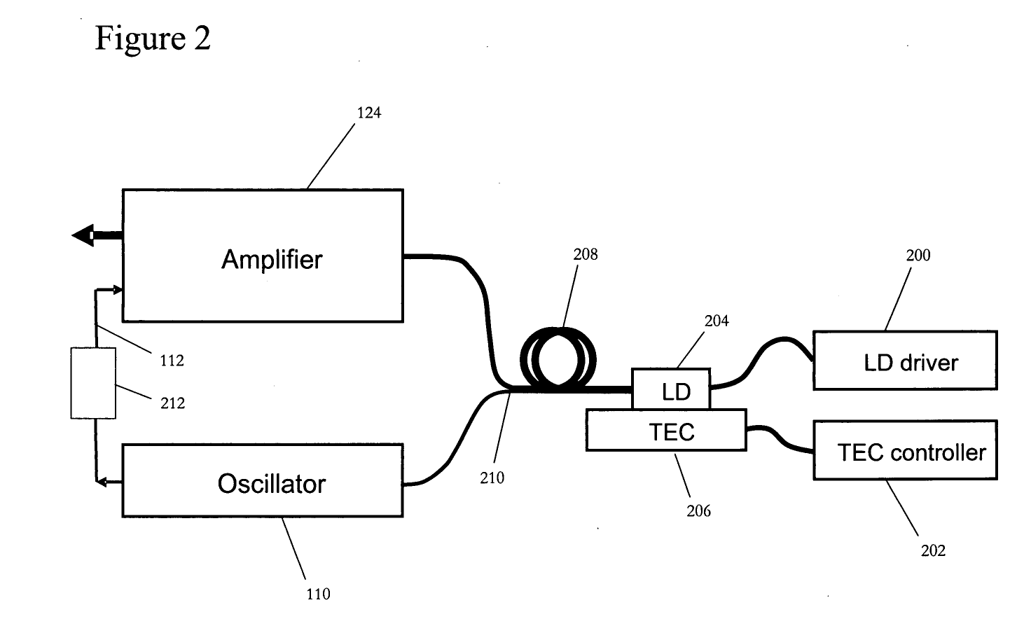

FIG. 2 illustrates an exemplary embodiment of the present invention. In this embodiment, optical pump 204 is desirably chosen to generate light at the pump wavelength with an output power equal or greater than the sum of the maximum pump powers desired for laser oscillator 110 and laser amplifier 124. Optical pump 204 is shown in FIG. 2 as a single fiber-coupled laser diode with power supplied by optical pump driver 200 and with its temperature controller by thermoelectric cooler (TEC) 206 and TEC controller 202. It is contemplated; however, that optical pump 204 may be another type of laser pump source, such as a laser diode, a flash lamp, a gas laser, an optical parametric oscillator, or a light emitting diode.

The exemplary embodiment of FIG. 2 utilizes a fused-fiber fiber optic splitter to split the pump beam. It is noted that the selection of a fused-fiber fiber optic splitter is exemplary and not intended to be limiting. For example, other optical splitters may be used in exemplary embodiments of the present invention, such as: free space optics that include a beam splitting mirror or a beam splitting prism; fiber optics that include a multiport star coupler, an evanescent fiber splitter, or a photonic crystal fiber splitter; or planar waveguide optics that include a Y waveguide splitter, an evanescent waveguide splitter, or a photonic crystal waveguide splitter.

Fiber splitter 210 has one input end to receive pump light from optical pump 204 and two output ends to couple first and second portions of the pump light into laser oscillator 110 and laser amplifier 124, respectively. Such a fiber splitter may be made by fusing two fibers, with one end of one fiber to the side of the other fiber. A fiber splitter may also be made by a special splitting/coupling joint. The fiber splitter is desirably designed such that the output power and cross sectional pump beam profile coupled into laser oscillator 110 from the first fiber output end are matched to the laser oscillator for efficient pumping of the laser oscillator and the output power and cross sectional pump beam profile coupled into laser amplifier 124 from the second fiber output end are matched to the laser amplifier for efficient pumping of the laser amplifier. As noted above, the fraction of the pump power level and the area of the cross sectional pump beam profile of the portion of the pump light coupled into the laser amplifier are typically larger than the fraction of the pump power level and the area of the cross sectional pump beam profile of the portion of the pump light coupled into the laser oscillator.

Laser oscillator 110 is adapted to generate laser light, having a predetermined laser wavelength, when its gain medium is irradiated with light that has the pump wavelength. The gain medium of the laser oscillator may be a solid state gain material, such as Nd:YAG or Ti:Sapphire, a laser dye, or a gaseous gain material. Laser oscillator 110 may be any sort of optically pumped laser oscillator. For example, the laser oscillator may a traveling wave ring laser oscillator, a standing wave ring laser oscillator, or a Fabry-Perot cavity laser oscillator. Also, the laser oscillator may operate as a single mode or a multimode laser oscillator. Additionally, the laser oscillator may be either a continuous wave laser oscillator or a pulsed laser oscillator.

Laser amplifier 124 is optically coupled to the laser oscillator via beam path 112 to receive the laser light generated by laser oscillator 110. It is noted that optical isolator 212 may be included in beam path 112 between the laser oscillator and the laser amplifier to reduce the amount of stray laser light that is coupled into the laser oscillator due to reflections off of, or leakage through, the laser light input port of laser amplifier 124. Laser amplifier 124 is adapted to amplify light having the laser wavelength when irradiated with light having the pump wavelength (i.e. when pumped). This laser amplifier may be a single pass laser amplifier or a multipass laser amplifier. Laser light is transmitted out of laser amplifier 124 through a laser light output port.

In the exemplary embodiment of FIG. 2, the laser amplifier 124 is shown as a box with the laser light input and output ports the same end of the box. The pump light is shown to be coupled into laser amplifier 124 on the other end. One skilled in the art will understand that there are numerous possible configurations for the optical coupling ports of a laser amplifier and that the illustration in FIG. 2 is schematic and not literal. In many laser amplifiers, the pump beam and the laser light from the laser oscillator are coupled into the gain medium through the same port. In other laser amplifiers, the pump beam is coupled into the gain medium through laser light output port. Additionally, it is contemplated that the pump beam of the laser amplifier may be split and coupled into the gain medium of the laser amplifier through both the laser light input port and the laser light output port.

As with the gain medium of the laser oscillator described above, the gain medium of the laser amplifier may be a solid state gain material, laser dye, or a gaseous gain material. The gain media in the laser oscillator and the laser amplifier are the same.

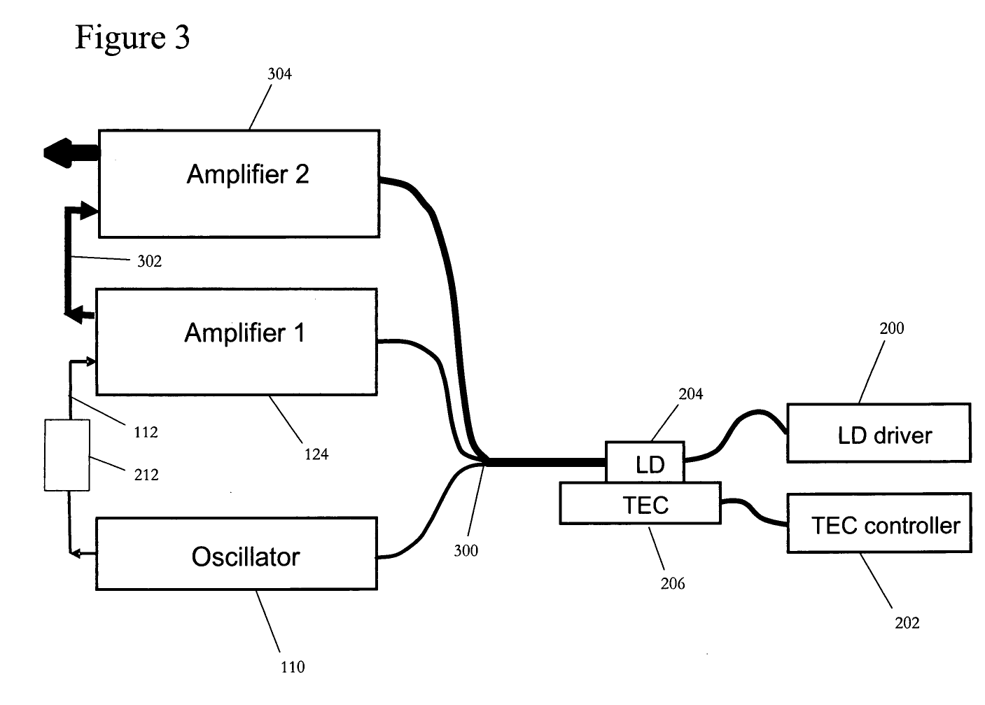

FIG. 3 illustrates an alternative exemplary embodiment of the present invention that includes further laser amplifier 304 optically coupled to receive the laser light amplified by laser amplifier 124 via optical path 302. The further laser amplifier is adapted to amplify light having the laser wavelength when also irradiated with light having the pump wavelength. Also shown in FIG. 3, is planar waveguide splitter 300, which additionally optically couples a third portion of the pump light having a third fraction of the pump power level into further laser amplifier 304. It is noted that, although FIG. 3 illustrates an amplified laser source with two laser amplifiers, more than two laser amplifiers may be used in an exemplary laser source without departing from the present invention, as long as at least two of the lasers are pumped by single optical pump 204.

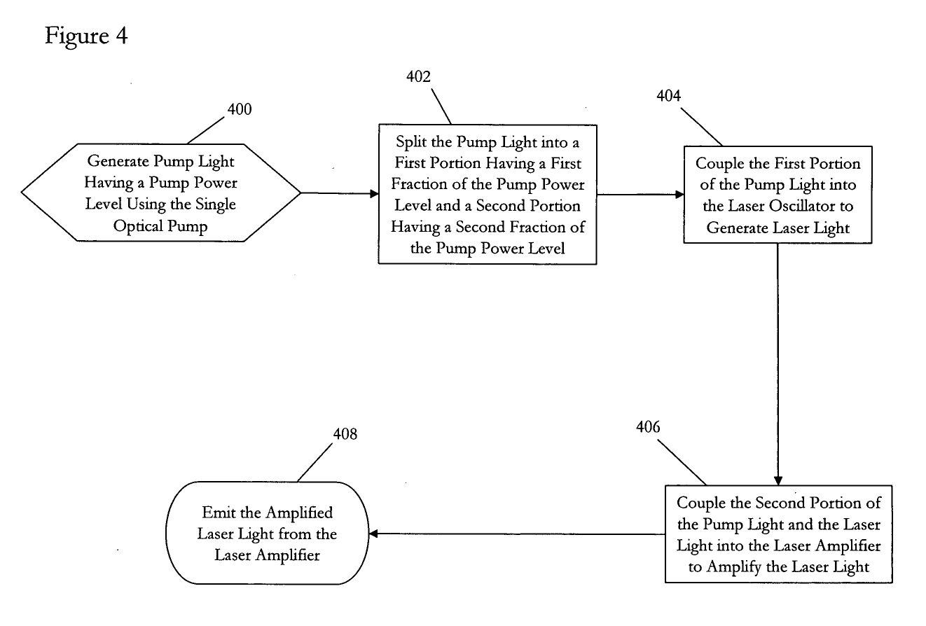

FIG. 4 illustrates an exemplary method of optically-pumping an amplified laser source using a single optical pump, which may be used with the various exemplary embodiments of the present invention. Pump light having a pump power level is generated using the single optical pump, step 400. This pump light is split into a first portion having a first fraction of the pump power level and a second portion having a second fraction of the pump power level, step 402. As noted above with reference to FIGS. 2 and 3, the pump light may be split into more portions depending of the configuration of the amplified laser source.

The first portion of the pump light is coupled into the laser oscillator to generate laser light, step 404. The coupled pump light desirably has a predetermined cross sectional pump beam profile. The second portion of the pump light is coupled into the laser amplifier along with the laser light generated by the laser oscillator to amplify the laser light, step 406. This coupled pump light also desirably has a predetermined cross sectional pump beam profile. The desired power level and cross sectional area of pump beam profile of the pump light coupled into the laser amplifier are typically larger than the desired power level and cross sectional area of pump beam profile of the pump light coupled into the laser oscillator. The amplified laser light is then emitted from the laser amplifier, step 408.

To illustrate the present invention, an exemplary Nd:YLF laser source containing a laser oscillator and a regenerative laser amplifier may be described with reference to FIG. 2. Laser oscillator 110 may be designed to be pumped using a fiber having a 200-μm core and an NA=0.22. The exemplary oscillator delivers 4 W of laser power at a wavelength of 808 nm, and the regenerative amplifier may be designed to be pumped using a fiber having a 400-μm core and an NA=0.22 to deliver 12 W of laser power at 808 nm. A fiber-coupled laser diode that can deliver at least 16 W of output power is chosen as optical pump 204, such as a commercially available 32-W laser diode having a 400-μm core and an NA=0.22. Beam splitter 210 may be a fiber splitter designed with an input end having 400-μm core diameter, NA=0.22, a first output end having 200-μm core, NA=0.22, and a second output end having 400-μm core, NA=0.22, and the power splitting ratio of 1:3 between the first and second fiber outputs. The two fiber outputs are used to pump laser oscillator 110 and laser amplifier 124, respectively. In operation, the laser diode may be adjusted to have a total output power of 16 W, with 4 W coming out of the first fiber output end and 12 W coming out of the second fiber output end.

It is desirable for at least one of the output fibers to have the same core diameter and numerical aperture as that of the input fiber to minimize loss in fiber splitting. However, this is not necessary. Additionally, it may be difficult to make a fiber splitter with the exact specified splitting ratio. Fortunately, laser oscillators may typically accept a range of pump power levels without significantly affecting their performance. For example, the Nd:YLF laser oscillator in this example may be designed to operate with 3-6 W of pump power. In this case, an exact splitting ratio is not critical for the design of the fiber splitter.

One advantage of exemplary embodiments of the present invention is reduced system complexity and simplified operation. With one optical pump, and the associated components used to operate that optical pump eliminated, the system becomes simpler and more compact. It may also be more reliable because the number of active optical and electronic components is reduced. Thus, there are fewer components to fail. Another advantage may be cost savings. Exemplary embodiments of the present invention eliminate one optical pump source of lower output power, which includes a fiber-coupled laser diode, a laser diode driver, a temperature control device such as a thermoelectric cooler (TEC) and controller.

The present invention includes a number of exemplary amplified laser sources and methods of operating these laser sources. Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An optically-pumped, amplified laser source including a single optical pump, the laser source comprising:
an optical pump to generate pump light, the pump light including a pump power level and a predetermined pump wavelength;
a laser oscillator adapted to generate laser light when irradiated with light having the pump wavelength, the laser light having a laser wavelength;
a laser amplifier optically coupled to the laser oscillator to receive the laser light generated by the laser oscillator, the laser amplifier adapted to amplify light having the laser wavelength when irradiated with light having the pump wavelength; and
beam splitting optics optically coupled to the optical pump, the laser oscillator, and the laser amplifier to couple a first portion of the pump light having a first fraction of the pump power level into the laser oscillator and a second portion of the pump light having a second fraction of the pump power level into the laser amplifier.

2. The laser source according to claim 1, wherein the optical pump is one of: a laser diode; a flash lamp; a gas laser; an optical parametric oscillator; or a light emitting diode.

3. The laser source according to claim 1, wherein a gain medium of the laser oscillator is one of a solid state gain material, laser dye, or a gaseous gain material.

4. The laser source according to claim 1, wherein the laser oscillator is one of a standing wave laser oscillator or a traveling wave ring laser oscillator.

5. The laser source according to claim 1, wherein the laser oscillator is one of a single mode laser oscillator or a multimode laser oscillator.

6. The laser source according to claim 1, wherein the laser oscillator is one of a continuous wave laser oscillator or a pulsed laser oscillator.

7. The laser source according to claim 1, wherein the laser amplifier is one of a single pass laser amplifier or a multipass laser amplifier.

8. The laser source according to claim 1, wherein the laser amplifier includes:
a laser light input port optically coupled to the laser oscillator to receive the laser light generated by the laser oscillator;
a laser light output port to transmit the amplified laser light; and
a gain medium optically coupled between the laser light input port and the laser light output port, the gain medium being absorptive to light having the pump wavelength.

9. The laser source according to claim 8, wherein the second portion of the pump light is optically coupled into the gain medium of the laser amplifier through one of the laser light input port or the laser light output port.

10. The laser source according to claim 8, wherein:
the beam splitting optics couple the second portion of the pump light into the gain medium of the laser amplifier through the laser light input port; and
the beam splitting optics further couple a third portion of the pump light having a third fraction of the pump power level into the gain medium of the laser amplifier through the laser light output port.

11. The laser source according to claim 8, wherein the gain medium of the laser amplifier is one of a solid state gain material, laser dye, or a gaseous gain material.

12. The laser source according to claim 1, wherein the beam splitting optics are one of:
fiber optics including a multiport star coupler;
fiber optics including a spliced fiber splitter;
fiber optics including an evanescent fiber splitter;
fiber optics including a photonic crystal fiber splitter;
free space optics including a beam splitting mirror;
free space optics including a beam splitting prism;
planar waveguide optics including a Y waveguide splitter;
planar waveguide optics including an evanescent waveguide splitter; or
planar waveguide optics including a photonic crystal waveguide splitter.

13. The laser source according to claim 1, wherein the beam splitting optics couple:
the first portion of the pump light into the laser oscillator with a first cross sectional pump beam profile; and
the second portion of the pump light into the laser amplifier with a second cross sectional pump beam profile.

14. The laser source according to claim 13, wherein a second area of the second cross sectional pump beam profile of the second portion of the pump light is larger than a first area of the first cross sectional pump beam profile of the first portion of the pump light.

15. The laser source according to claim 1, wherein the first fraction of the pump power level is less than or equal to the second fraction of the pump power level.

16. The laser source according to claim 1, further comprising an optical isolator optically coupled between the laser oscillator and the laser amplifier to reduce an amount of stray laser light coupled into the laser oscillator.

17. The laser source according to claim 1, further comprising:
a further laser amplifier optically coupled to the laser amplifier to receive the laser light amplified by the laser amplifier and optically coupled to the beam splitting optics to receive a third portion of the pump light having a third fraction of the pump power level;
wherein the further laser amplifier is adapted to amplify light having the laser wavelength when irradiated with light having the pump wavelength.

18. A method of optically-pumping an amplified laser source using a single optical pump, the method comprising the steps of:
a) generating pump light having a pump power level using the single optical pump;
b) splitting the pump light into a first portion having a first fraction of the pump power level and a second portion having a second fraction of the pump power level;
c) coupling the first portion of the pump light into a laser oscillator to generate laser light;
d) coupling the second portion of the pump light and the laser light into a laser amplifier to amplify the laser light; and
e) emitting the amplified laser light from the laser amplifier.

19. The method according to claim 18, wherein:
step (c) includes coupling the first portion of the pump light into the laser oscillator with a first cross sectional pump beam profile; and
step (d) includes coupling the second portion of the pump light into the laser amplifier with a second cross sectional pump beam profile.

20. The laser source according to claim 19, wherein a second area of the second cross sectional pump beam profile of the second portion of the pump light is larger than a first area of the first cross sectional pump beam profile of the first portion of the pump light.

21. An optically-pumped, amplified laser source including a single optical pump, the laser source comprising:
an optical pump to generate pump light, the pump light including a pump power level and a predetermined pump wavelength;
a laser oscillator adapted to generate laser light when irradiated with light having the pump wavelength, the laser light having a laser wavelength;
a laser amplifier optically coupled to the laser oscillator to receive the laser light generated by the laser oscillator, the laser amplifier adapted to amplify light having the laser wavelength when irradiated with light having the pump wavelength; and
fiber optics including:
an input fiber section optically coupled to the optical pump;
a first output fiber section optically coupled to the laser oscillator;
a second output fiber section optically coupled to the laser amplifier; and
a fiber splitter that couples:
a first portion of the pump light having a first fraction of the pump power level from the input fiber section into the first output fiber section; and
a second portion of the pump light having a second fraction of the pump power level from the input fiber section into the second output fiber section.

22. The laser source according to claim 21, wherein the fiber splitter is one of a multiport star coupler, a spliced fiber splitter, an evanescent fiber splitter, or a photonic crystal fiber splitter.
